(19) United States
(12) Patent Application Publication
(10) Pub. No.: US 2017/0269834 A1
(43) Pub. Date: Sep. 21, 2017

(54) DATA STORAGE DEVICE AND DATA MANAGEMENT METHOD THEREOF

(71) Applicant: Silicon Motion, Inc., Jhubei (TW)

(72) Inventors: Teng-Chi Liang, Hsinchu (TW); Yen-Ting Yeh, Taoyuan (TW)

(21) Appl. No.: 15/437,397

(22) Filed: Feb. 20, 2017

(30) Foreign Application Priority Data
Mar. 18, 2016 (TW) 105108490
Aug. 8, 2016 (TW) 105125097

(51) Int. Cl. G06F 3/06

(52) U.S. Cl. CPC G06F 3/061; G06F 3/064; G06F 3/0647; G06F 3/0656; G06F 3/0659; G06F 3/0679

(57) ABSTRACT

A data management method for a data storage device is provided. The data storage device includes a non-volatile memory. The non-volatile memory includes a plurality of pages. Each of the pages is configured to store a plurality of records of data. The data management method includes steps of: receiving a read command; reading target data from a data buffering storage device when the target data corresponding to the read command is stored in the data buffering storage device; determining whether an amount of data of remaining data in the data buffering storage device is greater than a threshold, wherein the remaining data is a part of subsequent data, and the target data and the remaining data have a sequential relationship in terms of data reading; and if the determination result is false, storing data in at least one subsequent page of the target data into the data buffering storage device.

### FIELD OF THE INVENTION

The present invention relates to a data storage device and a data management method thereof, and more particularly to a data storage device and a data management method thereof capable of reducing the number of times a non-volatile memory is read and increasing data reading efficiency.

### BACKGROUND OF THE INVENTION

Non-volatile memory is an electronic memory device. Because of having some features such as being capable of maintaining information without additional power, fast data access and shockproof capacity, non-volatile memory is widely used in memory cards, solid state drives and portable multimedia devices. When data stored in a non-volatile memory is read many times, the non-volatile memory may have read disturbance which may lead to improper data storage. Therefore, the non-volatile memory must be refreshed; however, the refresh may affect the service life of the non-volatile memory.

Non-volatile memory as a data storage medium of data storage devices has a system performance limitation, which is caused by the physical characteristics of non-volatile memory and the hardware and software design of data storage medium. Therefore, how to adjust the hardware and software design of the data storage medium to break through the limitation thereby providing better system performance is the goal of the manufacturer of data storage medium.

### SUMMARY OF THE INVENTION

In order to solve the above-mentioned drawbacks, the present invention provides a data management method, a data storage device and a memory controller for improving the efficiency of data reading of the data storage device.

The present invention provides a data management method for a data storage device. The data storage device includes a non-volatile memory. The non-volatile memory includes a plurality of pages. Each of the pages is configured to store a plurality of records of data. The data management method includes steps of: receiving a read command; reading target data from a data buffering storage device when the target data corresponding to the read command is stored in the data buffering storage device; determining whether an amount of data of remaining data in the data buffering storage device is greater than a threshold, wherein the remaining data is a part of subsequent data, and the target data and the remaining data have a sequential relationship in terms of data reading; and if the determination result is false, storing data in at least one subsequent page of the target data into the data buffering storage device.

The present invention further provides a data management method for a data storage device. The data storage device includes a non-volatile memory. The non-volatile memory includes a plurality of pages. Each of the pages is configured to store a plurality of records of data. The data management method includes steps of: receiving a read command; reading target data from a data buffering storage device according to the read command; determining whether an amount of data of remaining data in the data buffering storage device is greater than a threshold, wherein the remaining data is a part of subsequent data, and the target data and the remaining data have a sequential relationship in terms of data reading; and if the determination result is false, recording data in at least one subsequent page of the target data into the data buffering storage device.

The present invention further provides a data storage device. The data storage device includes a non-volatile data storage device and a memory controller. The non-volatile data storage device is for storing data. The memory controller is electrically coupled to the non-volatile data storage device and configured for outputting target data obtained from a page in the non-volatile data storage device. The memory controller is also configured to store subsequent data of the page into a volatile data storage device during processing of a read command. Both of the target data and the subsequent data are stored in the page. The memory controller is also configured to determine whether an amount of a remaining data stored in the volatile data storage device is greater than a threshold. The remaining data is a part of the subsequent data. If the determination is false, the memory controller is further configured to store at least one data in a subsequent page of the page into the volatile data storage device and incorporate the at least one data into the remaining data. The subsequent page and the page are adjacently located in the non-volatile data storage device.

The present invention still further provides a data management method for a data storage device. The data management method includes steps of: receiving a read command from a host; retrieving an address from the read command; locating and outputting a target data according to the address from a volatile data storage device; determining whether a remaining data stored in the volatile data storage device is greater than a threshold, wherein both of the target data and the remaining data are sequential data that belongs to a file and is stored in a page in a non-volatile data storage device; and storing data from a subsequent page of the page into the volatile data storage device and incorporating the data into the remaining data if the determination is false.

In summary, since the subsequent page can be pre-read to the data buffering storage device before the current page is read completely, the present invention allows the data buffering storage device to store the data with an amount more than one page. Therefore, when receiving the read command for reading the subsequent data, the data storage device can quickly read the required data from the data buffering storage device and reduce the number of read times of the non-volatile memory. Further, when a plurality of read commands are continuously issued and the data corresponding to the read commands has not been stored in the data buffering storage device, the data storage device can quickly read the corresponding data from the non-volatile memory and store the data into the data buffering storage device without waiting for the delay time caused by the read commands, thereby enhancing the efficiency of data reading of the data storage device.

### BRIEF DESCRIPTION OF THE DRAWINGS

Other advantages, objectives and features of the present invention will become apparent from the following description referring to the attached drawings.

FIG. 1 is a schematic block view of a data storage device in accordance with an embodiment of the present invention;

FIG. 2 is data management method in accordance with an embodiment of the present invention;

FIG. 3 is a schematic illustration of a plurality of pages of a block in accordance with an embodiment of the present invention;

FIG. 4A is a schematic diagram illustrating a conventional data management method; and

FIG. 4B is a schematic diagram illustrating a data management method in accordance with an embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

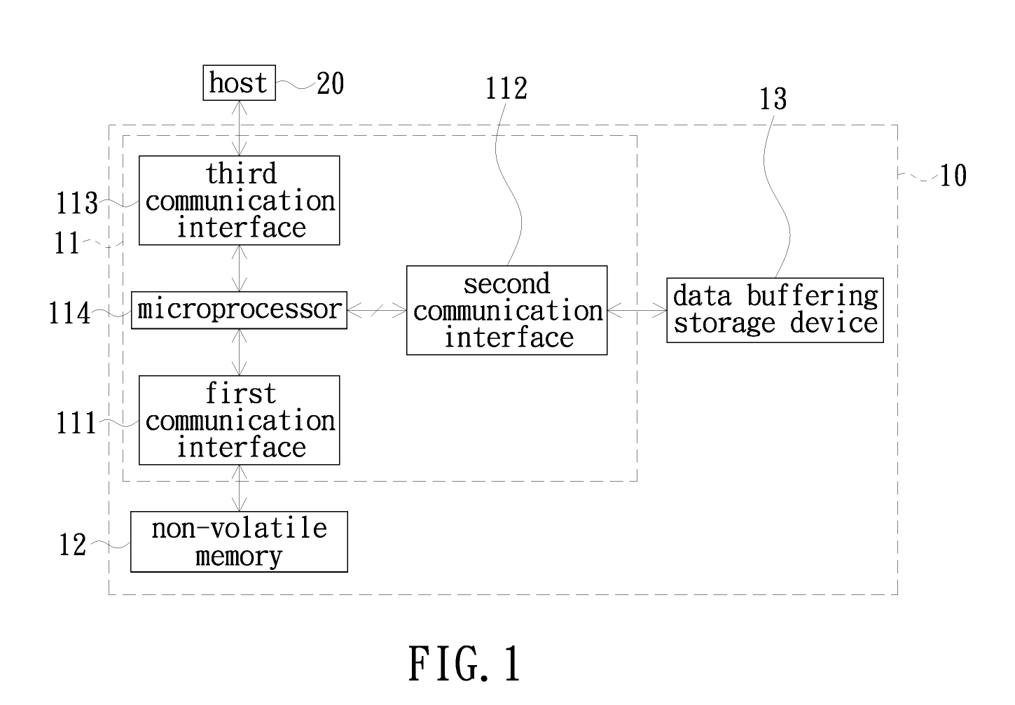

Please refer to FIG. 1, which is a schematic block view of a data storage device in accordance with an embodiment of the present invention. As shown in FIG. 1, the data storage device 10 of the present embodiment is in communication with an external host 20 and reads out data stored in the data storage device 10 according to a read command issued from the host 20. The aforementioned data may be image data for displaying or audio data; and the host 20 may be an electronic device such as a desktop computer or a tablet computer. The data storage device 10 includes a memory controller 11, a non-volatile memory 12 and a data buffering storage device 13. The non-volatile memory 12 is, for example, a data storage medium having relatively long data retention such as flash memory, magnetoresistive random access memory (magnetoresistive RAM), phase-change memory or ferroelectric RAM or phase-change memory. The data buffering storage device 13 is, for example, a dynamic random access memory (DRAM). The memory controller 11 is electrically coupled to the host 20, the non-volatile memory 12 and the data buffering storage device 13.

The memory controller 11 includes a first communication interface 111, a second communication interface 112, a third communication interface 113 and a microprocessor 114. The microprocessor 114 is electrically coupled to the first communication interface 111, the second communication interface 112 and the third communication interface 113. The memory controller 11 is able to communicate with and access the non-volatile memory 12 via the first communication interface 111. The memory controller 11 is able to communicate with and access the data buffering storage device 13 via the second communication interface 112. The memory controller 11 is able to communicate with the host 20 via the third communication interface 113. The non-volatile memory 12 includes a plurality of blocks. Each block includes a plurality of pages. Each page is used to store the aforementioned data so that the memory controller 11 can read the data necessary for the host 20 in sequence according to the read command.

The first communication interface 111 is compliance with, for example, open NAND flash interface (ONFI) or Toggle. The second communication interface 112 is, for example, compliance with DDR PHY Interface (DFI). The third communication interface 113 is, for example, serial advanced technology attachment (SATA), universal serial bus (USB), peripheral component interconnect express (PCI Express), serial microcomputer system (SAS), universal flash storage (UFS), embedded multimedia card (eMMC) or secure digital input/output (SDIO).

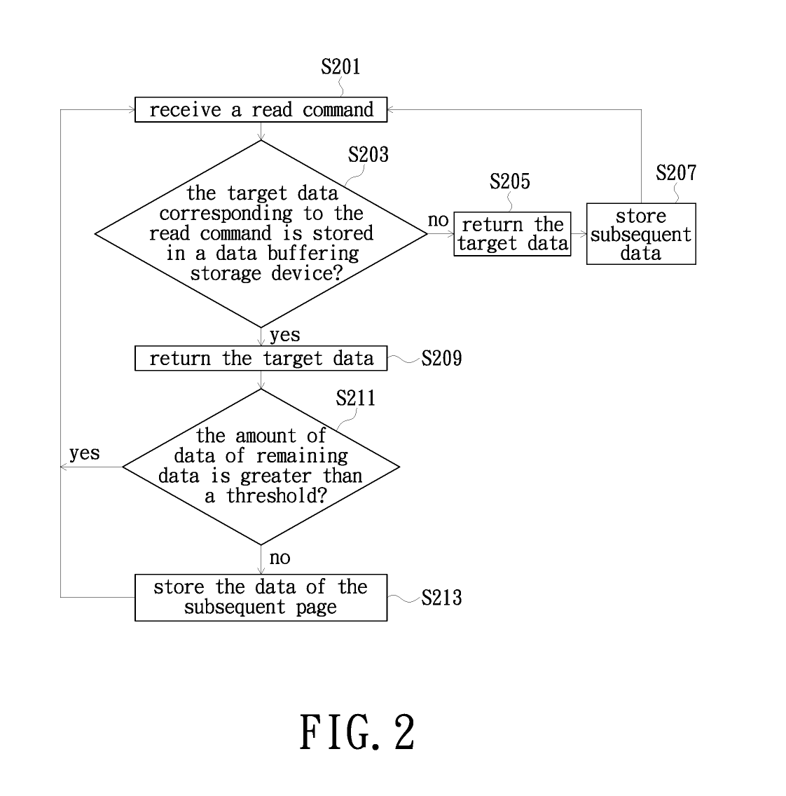

In order to provide better system performance of the data storage device 10 and reduce the number of times the non-volatile memory 12 is read, the present invention provides a data management method in which the data that may be read out from the non-volatile memory 12 is buffered in the data buffering storage device 13 in advance. And thus, the data storage device 10 can quickly respond to the read command from the host 20 thereby improving the system performance of the data storage device 10. The following, in combination of FIGS. 1, 2 and 3, describes a data management method in accordance with an embodiment of the present invention. In order to simply the description, the non-volatile memory 12 includes a plurality of pages, specifically, pages P1-P8 and other pages (not shown). Each page includes three sectors; wherein a sector is the smallest unit for data storage and addressing. A sector is configured to store data of 512 bytes in length and the data is corresponding to a logical block address (LBA). However, depending on the actual needs, a page may be configured to store 4096 bytes or 8192 bytes in length; or configured to include 8 sectors or 16 sectors; or set the size of each data as 1024 bytes or 4096 bytes in length. Due to the aforementioned settings are technically feasible, the present invention is not limited thereto.

The non-volatile memory 12 exemplarily stores four files, each of which is assigned a specific file identification code (File ID). Because each file has an unique file identification code, the microprocessor 114 can record start addresses of all the pages storing a specific file according to the file identification code; or store a start address of the first page storing the specific file, and thereby being knowledge of the start address of a subsequent page according to the contents of a prior page until find the symbol of the end of the file. In general, file is typically stored in a discontinuous manner. However, the manufacturer can store a file sequentially and successively in the data buffering storage device 13, in which case all the pages of each file are adjacent and stored in sequence. Because the start address is known, the absolute address of each record of data is known according to the relative address of each record of data in each page.

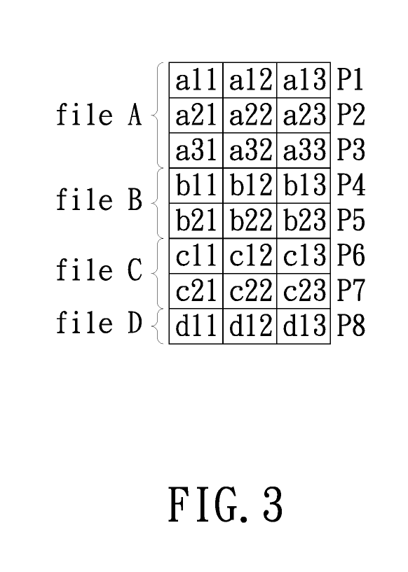

FIG. 3 is a schematic illustration of a plurality of pages of a block in accordance with an embodiment of the present invention. As shown in FIG. 3, the file A is stored in the pages P1, P2 and P3; the pages P1, P2, and P3 are adjacent pages; and the pages P2 and P3 are referred to as the subsequent pages of the page P1. The page P1 contains three records of data, which are the data a11, a12 and a13; the page P2 contains three records of data, which are the data a21, a22 and a23; and the page P3 contains three records of data, which are the data a31, a32 and a33. The file B is stored in the pages P4 and P5; the pages P4 and P5 are adjacent pages; and the page P5 is referred to as the subsequent page of the page P4. The page P4 contains three records of data, which are the data b 11, b12 and b13; and the page P5 contains three records of data, which are the data b21, b22 and b23. The file C is stored in the pages P6 and P7; the pages P6 and P7 are adjacent pages; and the page P7 is referred to as the subsequent page of the page P6. The page P6 contains three records of data, which are the data 11, c12 and c13; and the page P7 contains three records of data, which are the data c21, c22 and c23. The file d is stored in the page P8. The page P8 contains three records of data, which are the data d11, d12 and d13.

First, step S201: receiving a read command. Specifically, when the host 20 wants to read the target data (e.g., the data a11 of the file a) stored in the data storage device 10, the host 20 issues the read command to the data storage device 10 and the processor 114 of the data storage device 10 receives the read command transmitted from the host 20 via the third communication interface 113.

Thereafter, step S203: determining whether the target data corresponding to the read command is stored in the data buffering storage device 13. Specifically, after receiving the read command, the microprocessor 114 obtains an address (LBA) of the target data according to the address information contained in the read command and determines whether the target data is stored in the data buffering storage device 13 according to the address. Step S209 is performed if the determination result of step S203 is YES; alternatively, step S205 is performed if the determination result of step S203 is NO. The data buffering storage device 13 is preferably data register or data buffer such as dynamic random access memory (DRAM) or static random access memory (SRAM) having a higher average read speed than the non-volatile memory 12. Step S205 is then performed due to that it is assumed that the data a11 of the file A is stored only in the non-volatile memory 12 and is not stored in the data buffering storage device 13.

Thereafter, step S205: reading the page containing the target data and returning the target data. Specifically, the microprocessor 114 initiates a read operation to read a page (e.g., the page P1) containing the target data in the non-volatile memory 12 according to the address in order to obtain the target data (e.g., the data a11) and returns the target data to the host 20 via the third communication interface 113.

In another embodiment, step S205 is changed to: reading a page containing the target data and the subsequent page(s) and returning the target data. In the present embodiment, the total number of the subsequent page may be one (e.g., the page P2); or, the total number of the subsequent page may be two (e.g., the pages P2 and P3). The total number of the subsequent page may vary depending on the actual needs of users, and the present invention is not limited thereto. The subsequent page has been read and stored into the data buffering storage device 13, therefore, the microprocessor 114 can provide data to the host 20 quickly in the subsequent steps when the host 20 wants to read a plurality of sequential target data.

Thereafter, step S207: storing the subsequent data into the data buffering storage device 13, where the target data and the subsequent data are stored in the same page. Specifically, besides obtaining the target data from the page P1, the microprocessor 114 also obtains the subsequent data (e.g., the data a12 and a13) of the target data and stores the subsequent data into the data buffering storage device 13. In addition, the step S207 can further store the target data into the data buffering storage device 13. The advantage of not storing the target data into the data buffering storage device 13 is that the space usage amount of the data buffering storage device 13 can be saved. On the contrary, the advantage of storing the target data into the data buffering storage device 13 is that the microprocessor 114 can directly return the target data from the data buffering storage device 13 to the host 20 when the target data is repeatedly read, and thereby increasing the efficiency of data reading.

Thereafter, step S209: returning the target data. Specifically, when the determination result of step S203 is YES which indicates that the target data is stored in the data buffering storage device 13, the microprocessor 114 reads the target data (e.g., the data a12) from the data buffering storage device 13 according to the address and transmits the read target data to the host 20 via the third communication interface 113. Thus, the present embodiment not only reduces the number of times the microprocessor 114 performs step S205 but also increases the efficiency of data reading.

Thereafter, step S211: determining whether the amount of data of remaining data stored in the data buffering storage device 13 is greater than a threshold; wherein the remaining data is a part of the subsequent data, the target data and the remaining data have a sequential relationship in terms of the data reading, and the subsequent data subtract the target data equals the remaining data. Herein it is assumed that the threshold is one sector and the target data is the data a11; therefore, when step S207 is performed, the data a11 is transmitted to the host 20 and the data a12 and a13 is stored into the data buffering storage device 13. When the step S209 is performed, the target data is updated to the data a12 and the target data is transmitted to the host 20. Therefore, the remaining data stored in the data buffering storage device 13 is left with only the data a13, which has only one sector size and is not greater than the threshold; as a result, the determination result of step S211 is NO and step S213 is then performed. On the contrary, if the determination result of step S211 is YES, the process returns to step S201 to wait for the next read command. In another embodiment, the threshold may be a size of the amount of data, such as 1024 bytes or other values, preferably an integral multiple of a sector size. In addition, the amount of data of the remaining data can also be represented by the difference of addresses, for example, the maximum address value minus the minimum address value of the remaining data is the difference of addresses; and in this case, the threshold is preferably less than the number of sectors included in the page, such as integer 2, but the present invention is not limited thereto.

Thereafter, step S213: storing the data of the subsequent page into the data buffering storage device 13. Specifically, the microprocessor 114 obtains the addresses of the current page and the subsequent page according to the file identification code, and the subsequent page can be read from the non-volatile memory 12 according to the address of the subsequent page. Alternatively, the microprocessor 114 directly reads the subsequent page (e.g., the page P2) of the current page and stores the data (e.g., the data a21, a22 and a23) of the subsequent page into the data buffering storage device 13. After the data a21, a22 and a23 is stored into the data buffering storage device 13, the amount of data of remaining data is changed to four sectors by plus the already stored data al 3 and is greater than the threshold. Finally, the process returns to step S201 and waits for the next read command. In another embodiment, step S213 is changed to: storing the data of a plurality of subsequent pages (e.g., the pages P2 and P3) into the data buffering storage device 13. Assuming that the host 20 wants to read a number of continuous records of data, reading the plurality of subsequent pages and storing the data of the plurality of subsequent pages to the data buffering storage device 13 in step S213 not only reduce the number of times the microprocessor 114 performs step S213 but also increase the efficiency of data reading.

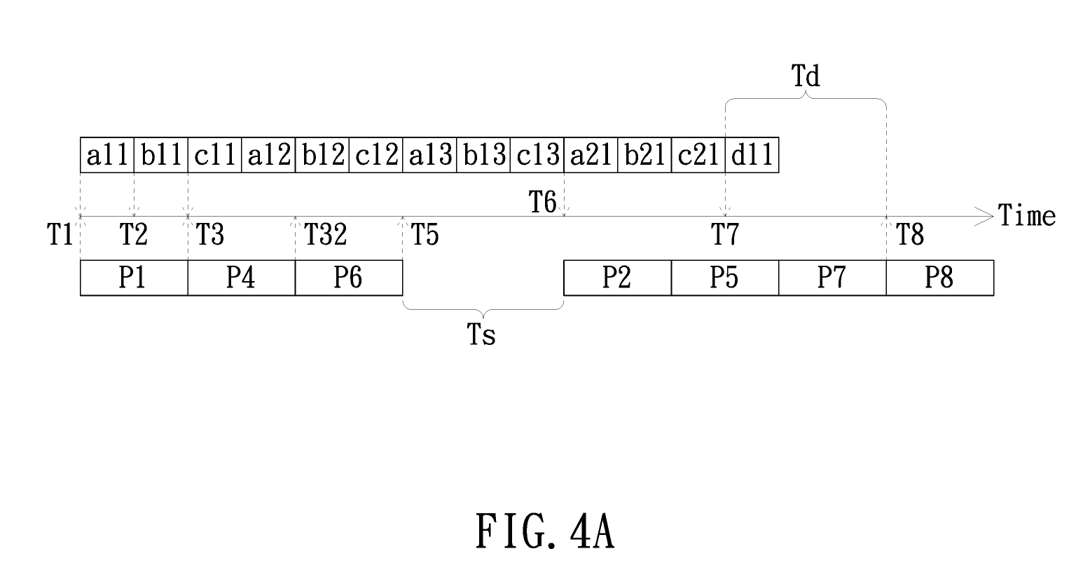

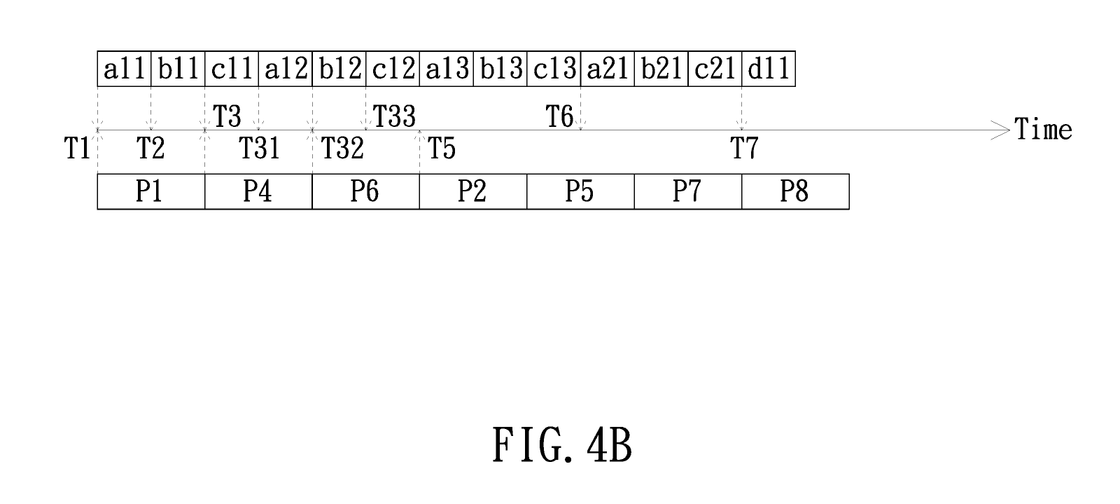

The data management method of the present invention will be further explained by FIGS. 4A and 4B. First, please refer to FIG. 4A, which is a schematic diagram illustrating a conventional data management method. In FIG. 4A, the horizontal axis is time Time; the plurality of records of data shown in the upper half of FIG. 4A are the target data that the host 20 requests from the memory controller 11 via the read commands; and the plurality of pages shown in the lower half of FIG. 4A are the pages in the data buffering storage device 13 where the memory controller 11 stores data according to the read commands. First, at time T1, when the host 20 issues the first read command for reading the data all of the file A, the memory controller 11 reads the page P1 from the non-volatile memory 12 at step S205 and stores the data a12 and a13 into the data buffering storage device 13 at step S207. At time T2, the host 20 issues a read command for reading the data b11 of the file b, and the memory controller 11 is still processing the page P1 and cannot process the read command. At time T3, the memory controller 11 reads the page P4 from the non-volatile memory 12 at step S205 and stores the data b12 and b13 into the data buffering storage device 13 at step S207. Also at time T3, the host 20 issues a read command for reading the data c11 of the file c, and the memory controller 11 is still processing the page P4 and cannot process the read command. At time T32, the memory controller 11 reads the page P6 from the non-volatile memory 12 at step S205 and stores the data c12 and c13 into the data buffering storage device 13 at step S207.

At time T6, the host 20 issues a read command for reading the data a21 of the file A, and the memory controller 11 reads the page P2 from the non-volatile memory 12 at step S205 and stores the data a22 and a23 into the data buffering storage device 13 at step S207. As shown in FIG. 4A, before the memory controller 11 receives the read command for the data a21 (that is, between time T5 and time T6), the memory controller 11 does not access the non-volatile memory 12 due to that the target data requested by the host 20 is already present in the data buffering storage device 13; wherein this period (between time T5 and time T6) is also referred to as the standby time Ts. At time T7, the host 20 issues a read command for reading the data d11 of the file d, the memory controller 11 is still processing the page P5 and then the page P7 and therefore cannot process the read command. At time T8, the memory controller 11 reads the page P8 from the non-volatile memory 12 at step S205 and stores the data d12 and d13 into the data buffering storage device 13 at step S207. Between time T7 and time T8, the memory controller 11 is still processing the pages P5 and P7 and therefore cannot read the page P8; wherein this period (between time T7 and time T8) is also referred to as delay time Td.

Please refer to FIG. 4B, which is a schematic diagram illustrating a data management method in accordance with an embodiment of the present invention. In FIG. 4B, the horizontal axis is time Time; the plurality of records of data shown in the upper half of FIG. 4B are the target data that the host 20 requests from the memory controller 11 via the read commands; and the plurality of pages shown in the lower half of FIG. 4B are the pages in the data buffering storage device 13 where the memory controller 11 stores data according to the read commands. The same time points in FIGS. 4A and 4B are labeled with the same time labels; for example, the time T1 in FIG. 4A and the time T1 in FIG. 4B represent the same time point, and so on. Same as FIG. 4A, the memory controller 11 sequentially reads the pages P1, P4 and P6 and stores the data a12, a13, b12, b13, c12 and c13 into the data buffering storage device 13 according to the read commands issued from the host 20. At time T31, when the host 20 issues a read command for reading the data a12 of the file A, the target data is updated to the data a12 and is transmitted to the host 20 at step 209, so that the remaining data leaves only the data a13 and the determination result of step S211 is NO. Accordingly, step S213 is performed to read the page P2 from the non-volatile memory 12 and store the data a21, a22 and a23 into the data buffering storage device 13. The similar operation also occurs at time T32 and time T33, except that the page to be read is the pages P5 and P7. Because step S213 is performed, the standby time Ts does not exist and the data of the subsequent pages (e.g., the pages P2, P5, and P7) are pre-read and stored into the data buffering storage device 13 instead. The advantage of the pre-read is the elimination or reduction of the standby time Ts, thereby eliminating or reducing the delay time Td. As shown in FIG. 4B, at time T7, the host 20 issues a read command for reading the data d11 of the file D, and the memory controller 11 can respond quickly to the read command issued from the host 20 at this time. The memory controller 11 reads the page P8 from the non-volatile memory 12 at step S205 and stores the data d12 and d13 into the data buffering storage device 13 at step S207, and therefore, the delay time Td is eliminated.

In summary, the data management method of the present invention can determine whether the amount of data currently stored in the data buffering storage device 13 is to be read completely (or greater than the threshold). If YES, the subsequent page is pre-read and the data of the subsequent page is stored into the data buffering storage device 13 so that the memory controller 11 can quickly transmit the target data or read the target data from the non-volatile memory 12 when the host 20 issues a read command, thereby reducing the impact of the delay time Td. Therefore, the number of read times of the non-volatile memory is reduced, the idle time and waiting time of the memory controller 11 are effectively reduced, and the efficiency of data reading is greatly improved.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A data management method for a data storage device, the data storage device comprising a non-volatile memory, the non-volatile memory comprising a plurality of pages, each of the pages being configured to store a plurality of records of data, and the data management method comprising steps of:
receiving a read command;
reading target data from a data buffering storage device when the target data corresponding to the read command is stored in the data buffering storage device;
determining whether an amount of data of remaining data in the data buffering storage device is greater than a threshold, wherein the remaining data is a part of subsequent data, and the target data and the remaining data have a sequential relationship in terms of data reading; and
if a result of the determination is false, storing data in at least one subsequent page of the target data into the data buffering storage device.

2. The data management method according to claim 1, further comprising steps of:
reading at least one of the pages containing the target data from the non-volatile memory if the target data corresponding to the read command is not stored in the data buffering storage device; and
storing the subsequent data in at least one of the pages into the data buffering storage device.

3. The data management method according to claim 1, further comprising steps of:
reading at least one of the pages containing the target data from the non-volatile memory if the target data corresponding to the read command is not stored in the data buffering storage device; and
storing the target data and the subsequent data in at least one of the pages into the data buffering storage device.

4. The data management method according to claim 1, wherein the threshold is smaller than a size of the page.

5. The data management method according to claim 1, wherein the amount of data is a difference between a maximum address value and a minimum address value of the remaining data.

6. The data management method according to claim 1, wherein the subsequent data subtract the target data is equal to the remaining data.

7. A data management method for a data storage device, the data storage device comprising a non-volatile memory, the non-volatile memory comprising a plurality of pages, each of the pages being configured to store a plurality of records of data, and the data management method comprising steps of:
receiving a read command;
reading target data from a data buffering storage device according to the read command;
determining whether an amount of data of remaining data in the data buffering storage device is greater than a threshold, wherein the remaining data is a part of subsequent data, and the target data and the remaining data have a sequential relationship in terms of data reading; and
if a result of the determination is false, recording data in at least one subsequent page of the target data into the data buffering storage device.

8. The data management method according to claim 7, further comprising steps of:
reading at least one of the pages containing the target data from the non-volatile memory according to the read command; and
recording the subsequent data in at least one of the pages into the data buffering storage device.

9. The data management method according to claim 7, further comprising steps of:
reading at least one of the pages containing the target data from the non-volatile memory according to the read command; and
recording the target data and the subsequent data in at least one of the pages into the data buffering storage device.

10. The data management method according to claim 7, wherein the threshold is smaller than a size of the page.

11. The data management method according to claim 7, wherein the amount of data is a difference between a maximum address value and a minimum address value of the remaining data.

12. The data management method according to claim 7, wherein the subsequent data subtract the target data is equal to the remaining data.

13. A data management method for a data storage device, comprising steps of:
receiving a read command from a host;
retrieving an address from the read command;
locating and outputting target data according to the address from a volatile data storage device;
determining whether remaining data stored in the volatile data storage device is greater than a threshold, wherein both of the target data and the remaining data are sequential data that belongs to a file and is stored in a page in a non-volatile data storage device; and
storing data from a subsequent page of the page into the volatile data storage device and incorporating the data into the remaining data if the determination is false.

14. The data management method according to claim 13, wherein the threshold is smaller than a size of the page.

15. The data management method according to claim 13, wherein the target and the remaining data are sequential data in terms of data reading.

16. The data management method according to claim 13, wherein the non-volatile data storage device is a flash memory and the volatile data storage device are dynamic random access memory (DRAM).

17. The data management method according to claim 13, wherein the target data is also stored in the non-volatile data storage device.

18. The data management method according to claim 13, wherein when the target data is located in the volatile data storage device, the target data is also stored in the non-volatile data storage device.

19. A data storage device, comprising:
a non-volatile data storage device for storing data; and
a memory controller, electrically coupled to the non-volatile data storage device for outputting target data obtained from a page in the non-volatile data storage device, for storing subsequent data of the page into a volatile data storage device during processing of a read command, for determining whether an amount of a remaining data stored in the volatile data storage device is greater than a threshold when both of the target data and the subsequent data are stored in the page, and if the determination is false, for storing at least one data in a subsequent page of the page into the volatile data storage device and incorporating the at least one data into the remaining data, wherein the remaining data is a part of the subsequent data, and the subsequent page and the page are adjacently located in the non-volatile data storage device.

20. The data storage device according to claim 19, wherein the target data and the subsequent data have a sequential relationship in terms of data reading.
